(19) United States
(12) Patent Application Publication
(10) Pub. No.: US 2018/0320045 A1
(43) Pub. Date: Nov. 8, 2018

(54) MANUFACTURING METHOD OF THERMAL DISSIPATING SLURRY AND THERMAL DISSIPATING STRUCTURE

(71) Applicant: Chung Yuan Christian University, Taoyuan City (TW)

(72) Inventors: Wei-Jen Liu, Taoyuan City (TW); Yi-Chin Lai, Taoyuan City (TW); Pin-Chun Lin, Taoyuan City (TW); Jhao-Yi Wu, New Taipei City (TW)

(73) Assignee: Chung Yuan Christian University, Taoyuan City (TW)

(21) Appl. No.: 15/790,068

(22) Filed: Oct. 23, 2017

(30) Foreign Application Priority Data
May 4, 2017 (TW) 106114757

(51) Int. Cl. C09K 5/14; B05D 3/12; B05D 3/02; B05D 5/00; C09D 7/12; C09D 127/16; C09D 5/00

(52) U.S. Cl. CPC C09K 5/14; B05D 3/12; B05D 3/0254; C08K 3/04; C09D 7/1216; C09D 127/16; C09D 5/00; B05D 5/00

(57) ABSTRACT

A manufacturing method of a thermal dissipating structure including following steps is provided. A carbon material is formed by performing a homogeneous cavitation process to a raw material of graphite. A thermal dissipating slurry is formed by mixing the carbon material and a binder. A thermal dissipating film is formed on a substrate by coating the thermal dissipating slurry on the substrate.

### CROSS-REFERENCE TO RELATED APPLICATION

This application claims the priority benefit of Taiwan application serial no. 106114757, filed on May 4, 2017. The entirety of the above-mentioned patent application is hereby incorporated by reference herein and made a part of this specification.

### BACKGROUND OF THE INVENTION

### Field of the Invention

The invention is related to a manufacturing method of a thermal dissipating material and a thermal dissipating element, and particularly related to a manufacturing method of a thermal dissipating slurry and a thermal dissipating structure using a homogenous cavitation process.

### Description of Related Art

Among research in thermal dissipating materials, the tendency of current research lies in using carbon materials such as graphene and the like as a thermal dissipating material. Currently, the preparation methods of graphene mainly include chemical vapor deposition (CVD) and chemical exfoliation.

However, using the CVD method to manufacture graphene is not only expensive but also cannot achieve mass production. In the chemical exfoliation method, graphite is oxidized and exfoliated via strong acid and strong oxidant to obtain graphite oxide, and then the graphite oxide is delaminated via high temperature and ultra-sonication to obtain graphene. The manufacturing process not only causes pollution to the environment easily, the obtained graphene has more defects, and such defects affect the thermal conductivity of graphene.

Therefore, currently the industry would like to develop a manufacturing process that is not only environmental-friendly but also can easily achieve mass production to manufacture carbon material with good thermal conductivity.

### SUMMARY OF THE INVENTION

The invention provides a manufacturing method of a thermal dissipating slurry that is environmental-friendly and can easily achieve mass production.

The invention provides a manufacturing method of a thermal dissipating structure having good thermal conductivity.

The invention provides a manufacturing method of a thermal dissipating slurry, comprising the following steps. A homogeneous cavitation process is performed to a raw material of graphite to form a carbon material. The carbon material and a binder are mixed.

According to one embodiment of the invention, in a manufacturing method of a thermal dissipating slurry, a raw material of graphite is, for example, natural graphite, artificial graphite, pitch, activated carbon, single-wall carbon nanotubes, multi-wall carbon nanotubes or a combination thereof.

According to one embodiment of the invention, the manufacturing method of thermal dissipating slurry further comprises mixing the raw material of graphite in a solvent before performing the homogeneous cavitation process to the raw material of graphite.

According to one embodiment of the invention, in the manufacturing method of thermal dissipating slurry, the solvent is, for example, water, ethanol, N-methyl-2-pyrrolidone (NMP), isopropanol or a combination thereof.

According to one embodiment of the invention, in the manufacturing method of thermal dissipating slurry, the pressure applied in the homogeneous cavitation process is, for example, more than 0 bar and less than 3000 bar.

According to one embodiment of the invention, in the manufacturing method of thermal dissipating slurry, the homogeneous cavitation process is performed at a temperature of, for example, higher than 4° C. and lower than 50° C.

According to one embodiment of the invention, in the manufacturing method of thermal dissipating slurry, the number of times of performing the homogeneous cavitation process is more than one time and less than 100 times, for example.

According to one embodiment of the invention, in the manufacturing method of thermal dissipating slurry, the carbon material is, for example, a graphene, a few-layer graphene, a multi-layer graphene or a combination thereof.

The invention also provides a manufacturing method of a thermal dissipating structure, which comprises the following steps. A carbon material is formed by performing a homogeneous cavitation process to the raw material of graphite. A thermal dissipating slurry is formed by mixing the carbon material and a binder. A thermal dissipating film is formed on a substrate by coating the thermal dissipating slurry on the substrate.

According to one embodiment of the invention, in the manufacturing process of thermal dissipating structure, the pressure applied in the homogeneous cavitation process is, for example, more than 0 bar and less than 3000 bar.

According to one embodiment of the invention, in the manufacturing process of thermal dissipating structure, the homogeneous cavitation process is performed at a temperature of, for example, higher than 4° C. and lower than 50° C.

According to one embodiment of the invention, the number of times of performing the homogeneous cavitation process is more than one time and less than 100 times, for example.

According to one embodiment of the invention, in the manufacturing method of thermal dissipating slurry, the carbon material is, for example, a graphene, a few-layer graphene, a multi-layer graphene or a combination thereof.

According to one embodiment of the invention, in the manufacturing method of thermal dissipating structure, the step of mixing the carbon material and the binder to form the thermal dissipating slurry further includes mixing graphite or conductive carbon black in the thermal dissipating slurry.

According to one embodiment of the invention, in the manufacturing method of thermal dissipating structure, the material of the substrate is, for example, a metallic material, a polymer material or a combination thereof. The metallic material is, for example, copper, aluminum or a combination thereof. The polymer material is, for example, polyethylene terephthalate.

According to one embodiment of the invention, in the manufacturing method of thermal dissipating structure, the thermal dissipating film may be formed on a first surface of the substrate and a second surface opposite to the first surface.

According to one embodiment of the invention, in the manufacturing method of thermal dissipating structure, a thickness of the thermal dissipating film is, for example, from 10 μm to 100 μm.

According to one embodiment of the invention, in the manufacturing method of thermal dissipating structure, a thickness of the substrate is, for example, from 10 μm to 50 μm.

According to one embodiment of the invention, the manufacturing method of thermal dissipating structure further includes performing a rolling step to the thermal dissipating film after forming the thermal dissipating film on the substrate.

According to one embodiment of the invention, the manufacturing method of thermal dissipating structure further includes performing a drying process to the thermal dissipating film before performing the rolling process to the thermal dissipating film.

Based on the above, in the manufacturing method of thermal dissipating slurry and thermal dissipating structure provided by the invention, the homogeneous cavitation process is performed to the raw material of graphite to form the carbon material with high quality and few defects so that the obtained carbon material has good thermal conductivity and excellent mechanical property. In addition, the homogeneous cavitation process has the characteristics of being easy to perform, capable of continuous production and environmental-friendly. Accordingly, the manufacturing method of thermal dissipating slurry and thermal dissipating structure provided by the invention can manufacture the thermal dissipating slurry and thermal dissipating structure having good thermal conductivity via an eco-friendly method and can easily achieve mass production.

In order to make the aforementioned features and advantages of the invention more comprehensible, embodiments accompanying figures are described in detail below.

### BRIEF DESCRIPTION OF THE DRAWINGS

FIG. 1 is a flowchart illustrating a manufacturing method of a thermal dissipating slurry and a thermal dissipating structure according to one embodiment of the invention.

FIGS. 2A, 2B and 2C are scanning electron microscope (SEM) images of a raw material of graphite before a homogeneous cavitation process is performed in different embodiments of the invention.

FIGS. 2D, 2E and 2F are the SEM images of the raw material of graphite after the homogeneous cavitation process is performed in different embodiments.

FIGS. 3A, 3B and 3C are SEM images of an obtained carbon material after the homogeneous cavitation process is performed for different times according to one embodiment of the invention, wherein an enlargement magnification of the image is 1000 times.

FIGS. 3D, 3E and 3F are the SEM images of the obtained carbon material after the homogeneous cavitation process is performed for different times according to one embodiment of the invention, wherein an enlargement magnification of the image is 10000 times.

FIG. 4 is an atomic force microscope (AFM) image of a carbon material according to one embodiment of the invention.

FIG. 5A is a thickness distribution diagram taken along line I-I′ in FIG. 4.

FIG. 5B is a thickness distribution diagram taken along line II-II′ in FIG. 4.

FIG. 5C is a thickness distribution diagram taken along line in FIG. 4.

FIGS. 6A to 6D are transmission electron microscopy (TEM) images of a carbon material according to one embodiment of the invention.

FIGS. 7A to 7F are comparative diagrams of thermal conduction tests performed to a substrate, Example 1, Comparative Example 1 and Comparative Example 2 by using a thermography.

### DESCRIPTION OF EMBODIMENTS

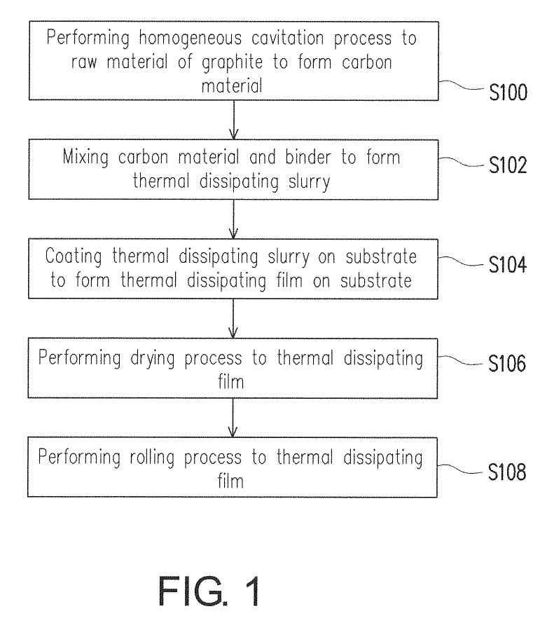

FIG. 1 is a flowchart illustrating a manufacturing method of a thermal dissipating slurry and a thermal dissipating structure according to one embodiment of the invention.

Referring to FIG. 1, a step S100 is performed by carrying out a homogeneous cavitation process to a raw material of graphite to from a carbon material. The raw material of graphite is, for example, natural graphite, artificial graphite, pitch, activated carbon, a single-wall carbon nanotube, a multi-wall carbon nanotube or a combination thereof. The artificial graphite is, for example, a graphite sheet, wherein the graphite sheet is formed by graphitizing polyimide (PI) via a high-temperature sintering process; therefore, the graphite sheet can also be referred to as PI film. In one embodiment, the raw material of graphite is, for example, in the form of powder. A carbon material obtained by performing the homogeneous cavitation progress to the raw material of graphite is, for example, a graphene, a few-layer graphene, a multi-layer graphene or a combination thereof. The “few-layer graphene” refers to graphene having more than 1 layer and less than 10 layers. The “multi-layer graphene” refers to graphene having 10 layers or more.

In addition, before the homogenous cavitation process is performed to the raw material of graphite, the raw material of graphite may be selectively dispersed in a solvent. The solvent is, for example, water, ethanol, N-methyl-2-pyrrolidone (NMP), isopropanol or a combination thereof.

In one embodiment, the homogeneous cavitation process is performed to disrupt the raw material of graphite via a pressure difference. For instance, the homogenous cavitation progress may be performed to the raw material of graphite by using a continuous cell disrupter. The raw material of graphite is instantly released at an outlet of the continuous cell disrupter in a high-pressure environment, causing the layers of raw material of graphite to be instantly peeled off so that the carbon in the layers of the raw material of graphite can be delaminated to form the carbon material. The pressure of the homogeneous cavitation process is, for example, more than 0 bar and less than 3000 bar. The temperature of the homogeneous cavitation process is, for example, higher than 4° C. and lower than 50° C. The number of times of performing the homogeneous cavitation process is more than 1 time and less than 100 times, for example.

A step S102 is performed to mix the carbon material and a binder to form a thermal dissipating slurry. In some embodiments, the binder is, for example, a liquid fluid that can be directly mixed with carbon material to form the thermal dissipating slurry. In some other embodiments, the binder is, for example, solid powder, therefore, in the step of mixing the carbon material and binder, it is required to additionally add a solvent that can dissolve the binder. For example, the solvent that is used for dissolving the binder may be polyvinylidene difluoride (PVDF), carboxy methyl cellulose (CMC) or a combination thereof. In one embodiment, in the step of mixing the carbon material and the binder to form the thermal dissipating slurry, the graphite or conductive carbon black may be selectively mixed in the thermal dissipating slurry. The binder is, for example, PVDF, CMC or a combination thereof.

A step S104 is performed to coat the thermal dissipating slurry on the substrate to form a thermal dissipating film on the substrate. The substrate and thermal dissipating film may be used to form a thermal dissipating structure. The substrate may be in the form of a plate or sheet so that the thermal dissipating structure is formed as a thermal dissipating sheet or thermal dissipating plate, which should not be construed as a limitation to the invention. Persons of ordinary skill in the art can adjust the form of thermal dissipating structure depending on the design requirement of product. The material of the substrate is, for example, a metallic material, a polymer material or a combination thereof. The metallic material is, for example, copper, aluminum or a combination thereof. The polymer material is, for example, polyethylene terephthalate. The thickness of the substrate is, for example, from 10 μm to 50 μm. The thickness of the thermal dissipating film is, for example, from 10 μm to 100 μm.

In addition, to improve the thermal dissipating effect, the thermal dissipating film may be selectively coated on a first surface of the substrate and a second surface opposite to the first surface to increase the area of thermal dissipating film coated on the substrate, thereby further enhancing the thermal dissipating effect of the thermal dissipating structure.

A step S106 may be performed selectively to carry out a drying process to the thermal dissipating film so as to reduce the drying time of the thermal dissipating film. The temperature of the drying process is, for example, from 40° C. to 250° C.

A step S108 can be selectively performed to carry out a rolling process to the thermal dissipating film so as to increase the adhesion between the thermal dissipating film and the substrate. In the embodiment, the drying process (step S106) is performed to the thermal dissipating film first, and the rolling process is performed to the thermal dissipating film subsequently, which should not be construed as a limitation to the invention. In other embodiments, the rolling process may be performed to the thermal dissipating film immediately after forming the thermal dissipating film (step S104).

Based on the above embodiments, it can be obtained that the manufacturing method of thermal dissipating slurry and thermal dissipating structure provided by the above embodiments performs the homogeneous cavitation process to the raw material of graphite to form the carbon material with high quality and few defects, such that the obtained carbon material has good thermal conductivity and excellent mechanical property. In addition, the homogeneous cavitation process has the characteristics of being easy to perform, capable of achieving mass production and eco-friendly. Therefore, the manufacturing method of the thermal dissipating slurry and thermal dissipating structure provided by the above embodiments can manufacture the thermal dissipating slurry and thermal dissipating structure having good thermal conductivity via the method that is environment-friendly and can easily achieve mass production.

### EXPERIMENTAL EXAMPLES

### Experiment 1

Experiment 1 applies different pressure to the raw material of graphite to perform the homogeneous cavitation process. The process is exemplified by using 800 bar, 1300 bar and 1800 bar of pressure for description, which should not be construed as a limitation to the invention. In addition, Experiment 1 uses artificial graphite (model no. CPC-B, manufactured by CPC Corporation, Taiwan) as an example of the raw material of graphite for description. The homogeneous cavitation process is performed for three times as an example, which should not be construed as a limitation to the invention. The result of Experiment 1 is described in Table 1 below.

TABLE 1

| Pressure (bar) | Number of times | Particle diameter (μm) |
|---|---|---|
| 0 | 0 | 479.13 |
| 800 | 3 | 45.39 |
| 1300 | 3 | 25.24 |
| 1800 | 3 | 15.09 |

Table 1 shows that, after the homogeneous cavitation process is performed to the raw material of graphite, the particle diameter of the obtained carbon material is smaller than the particle diameter of the raw material of graphite. In addition, as the pressure used in the homogeneous cavitation process is increased, the particle diameter of the carbon material is decreased.

### Experiment 2

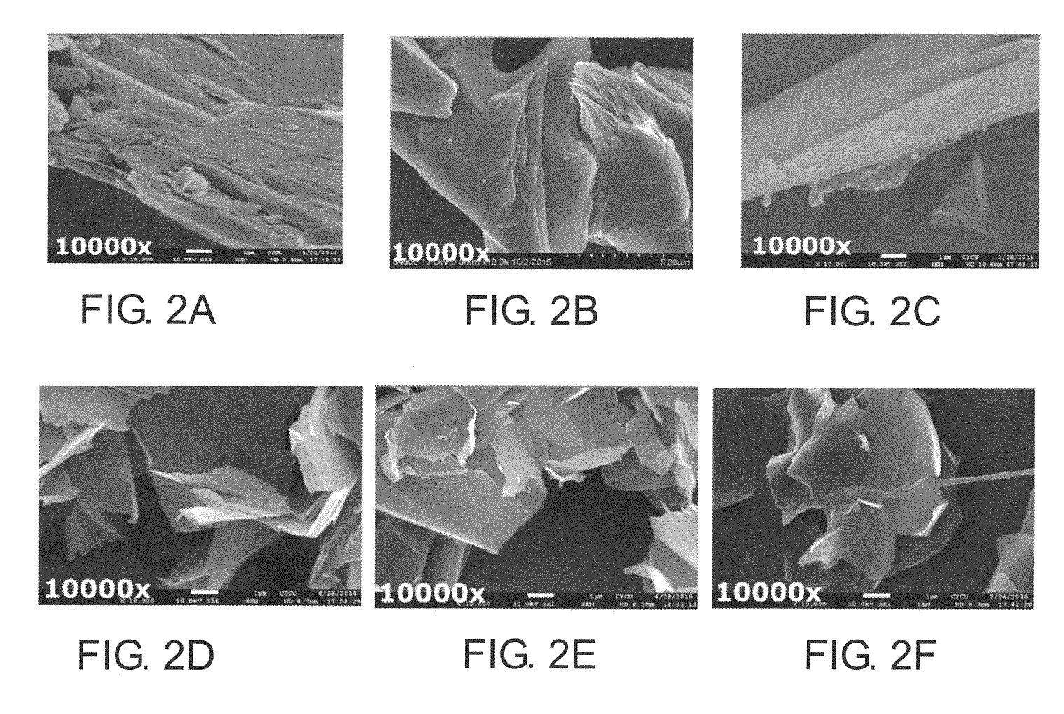

FIGS. 2A, 2B and 2C are scanning electron microscope (SEM) images of a raw material of graphite before a homogeneous cavitation process is performed in different embodiments of the invention. FIGS. 2D, 2E and 2F are the SEM images of the raw material of graphite after the homogeneous cavitation process is performed in different embodiments.

In order to more specifically demonstrate the difference between the raw material of graphite before/after the homogeneous cavitation process is performed, the SEM is used to carry out a surface analysis. Experiment 2 uses natural graphite, artificial graphite (model no. CPC-B, manufactured by CPC Corporation, Taiwan) and graphite sheet as examples of the raw material of graphite for description, which should not be construed as a limitation to the invention. In addition, the homogeneous cavitation process in Experiment 2 is exemplified by using 1800 bar to 2000 bar (high pressure) of pressure for description, and is performed for three times as an example (the pressure is increased from 1800 bar to 2000 bar in each time of the homogeneous cavitation process), which should not be construed as a limitation to the invention.

Referring to FIGS. 2A to 2F, the SEM images are observed at an enlargement magnification of 10000 times. FIGS. 2A and 2D are images of the natural graphite before/after the homogeneous cavitation process is performed. FIGS. 2B and 2E are images of the artificial graphite before/after the homogeneous cavitation process is performed. FIGS. 2C and 2F are images of the graphite sheet before/after the homogeneous cavitation process is performed. Comparing the images of the raw material of graphite before/after the homogeneous cavitation process is performed in different embodiments, it can be obtained that the surface appearance of the raw material of graphite is significantly changed after the homogeneous cavitation process is performed.

### Experiment 3

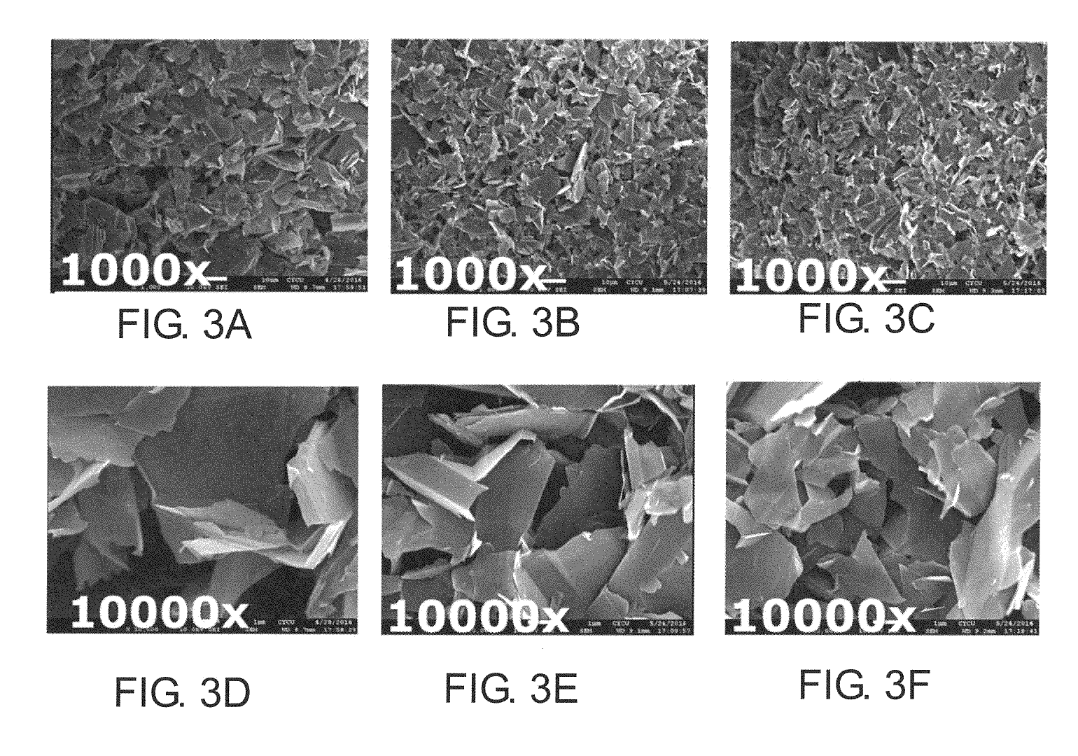

FIGS. 3A, 3B and 3C are SEM images of an obtained carbon material after the homogeneous cavitation process is performed for different times according to one embodiment of the invention, wherein an enlargement magnification of the image is 1000 times. FIGS. 3D, 3E and 3F are the SEM images of the obtained carbon material after the homogeneous cavitation process is performed for different times according to one embodiment of the invention, wherein an enlargement magnification of the image is 10000 times.

To more specifically demonstrate the difference in surface appearance of the raw material of graphite after performing different times of homogeneous cavitation processes, the SEM is used to carry out surface analysis. The number of times that the homogeneous cavitation processes is performed is 3 times, 8 times and 12 times as examples for descriptions, which should not be construed as a limitation to the invention. Experiment 3 uses artificial graphite (model no. CPC-B, manufactured by CPC Corporation, Taiwan) as an example of the raw material of graphite for description, which should not be construed as a limitation to the invention. In addition, the homogeneous cavitation process in Experiment 3 is exemplified by using 2000 bar of pressure for description, which should not be construed as a limitation to the invention.

Referring to FIGS. 3A to 3E, the SEM images are observed at an enlargement magnification of 1000 times and 10000 times. FIGS. 3A and 3D are images of the raw material of graphite to which the homogeneous cavitation process is performed for 3 times. FIGS. 3B and 3E are images of the raw material of graphite to which the homogeneous cavitation process is performed for 8 times. FIGS. 3C and 3F are images of the raw material of graphite to which the homogeneous cavitation process is performed for 12 times. The experiment results are shown in FIGS. 3A to 3F and Table 2.

TABLE 2

| Pressure (bar) | Number of times | Particle diameter (μm) |
|---|---|---|
| 2000 | 3 | 18.88 |
| 2000 | 8 | 11.31 |
| 2000 | 12 | 8.53 |

FIGS. 3A to 3F and Table 2 show that, as the number of times of performing the homogeneous cavitation process is increased, the particle diameter of the carbon material is decreased.

### Experiment 4

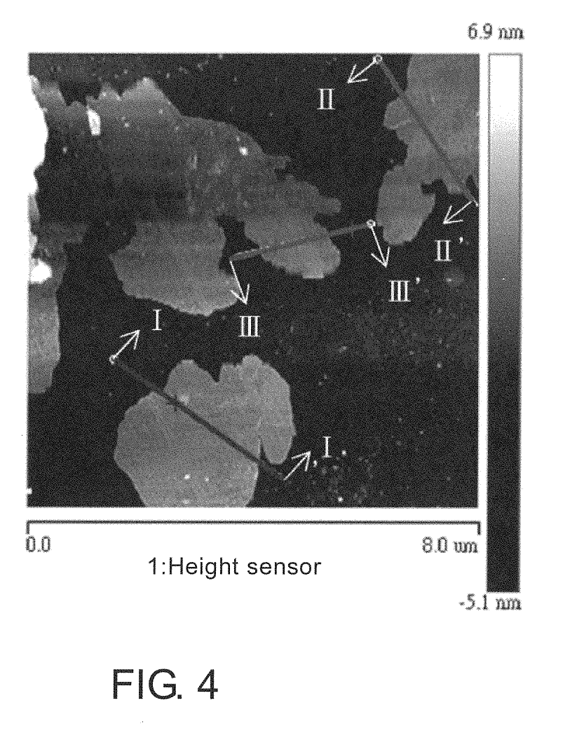

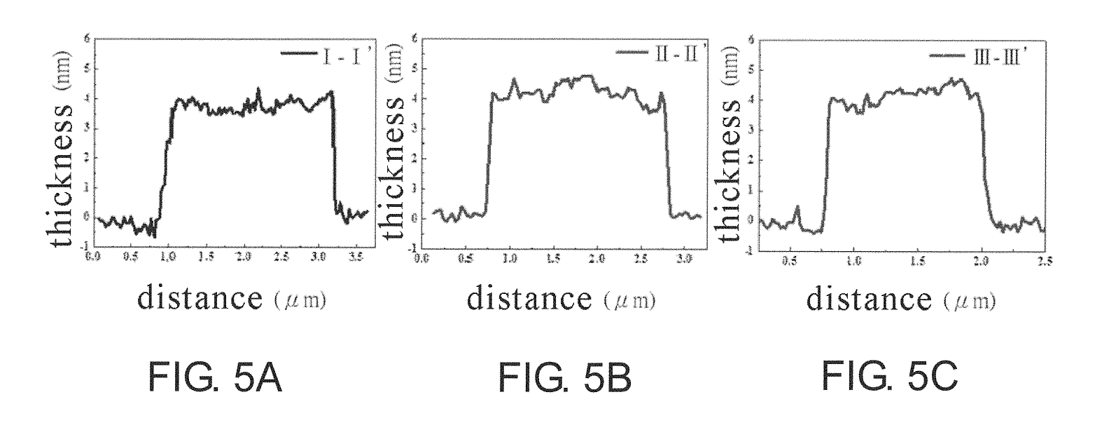

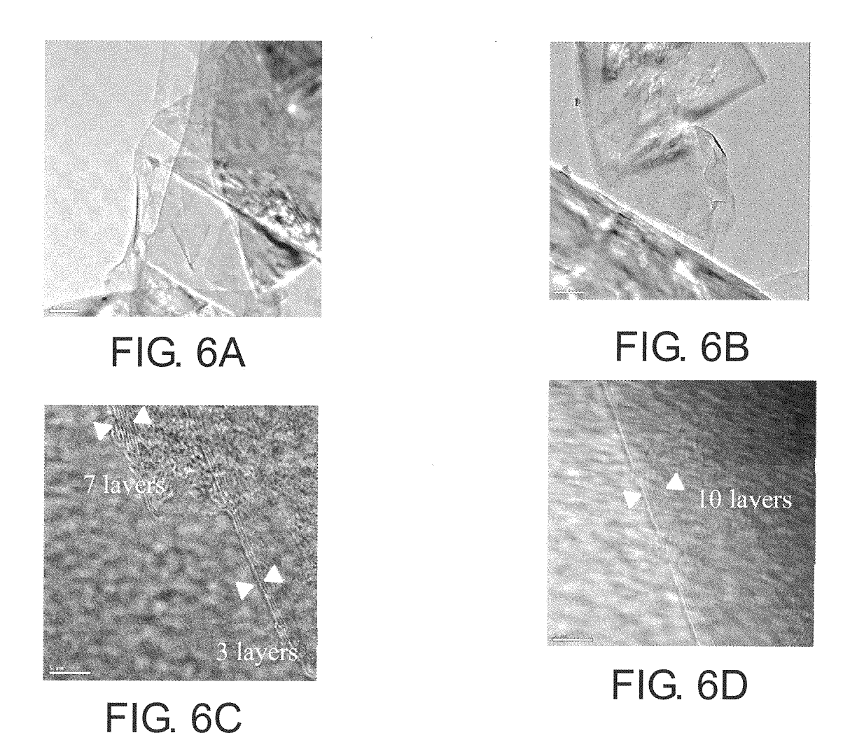

FIG. 4 is an atomic force microscope (AFM) image of the carbon material according to one embodiment of the invention. FIG. 5A is a thickness distribution diagram taken along line I-I′ in FIG. 4. FIG. 5B is a thickness distribution diagram taken along line II-II′ in FIG. 4. FIG. 5C is a thickness distribution diagram taken along line in FIG. 4. FIGS. 6A to 6D are transmission electron microscopy (TEM) images of a carbon material according to one embodiment of the invention.

To more specifically demonstrate the thickness of the carbon material that is formed after the homogeneous cavitation process is performed to the raw material of graphite, transmission electron microscopy (TEM) and atomic force microscopy (AFM) are used to analyze the surface appearance and thickness distribution of the carbon material. Experiment 4 uses natural graphite as an example of the raw material of graphite for description, which should not be construed as a limitation to the invention. In addition, the homogeneous cavitation process in Experiment 4 is exemplified by using 1800 bar to 2000 bar (high pressure) of pressure for description, and is performed for three times as an example (the pressure is increased from 1800 bar to 2000 bar in each time of the homogeneous cavitation process), which should not be construed as a limitation to the invention.

Referring to FIGS. 4, 5A to 5C and Table 3 below, based on the thickness distribution diagram in FIG. 5A, it can be calculated that an average thickness of the carbon material taken along line I-I′ in FIG. 4 is 3.81 nm. Based on the thickness distribution diagram in FIG. 5B, it can be calculated that the average thickness of the carbon material taken along line II-II′ in FIG. 4 is 4.07 nm. Based on the thickness distribution diagram in FIG. 5C, it can be calculated that the average thickness of the carbon material taken along line in FIG. 4 is 4.79 nm. Next, by calculating the mean of the average thickness of the carbon material taken along lines I-I′, II-II′ and in FIG. 4, it can be obtained that, after the homogeneous cavitation process is performed, the average thickness of the raw material of graphite is 4.22 nm. The calculation results of the thickness analysis are described in Table 3.

TABLE 3

| Marking | Thickness (nm) |
|---|---|
| Line I-I′ | 3.81 |
| Line II-II′ | 4.07 |
| Line III-III′ | 4.79 |
| Average thickness | 4.22 |

FIGS. 6A to 6D and Table 3 show that the number of layer of the carbon material that is formed after the homogeneous cavitation process is performed to the raw material of graphite is between 3 layers and 10 layers. Therefore, according to the average thickness indicated in Table 3, it can be calculated that the thickness of each layer of the carbon material is between about 0.4 nm and about 1.4 nm.

The features of the invention are described more specifically as follows by referring to Example 1, Example 2, Comparative Example 1 and Comparative Example 2. Although the following experimental examples are described, the materials used and the amount and ratio thereof, as well as handling details and handling process . . . etc., can be suitably modified without exceeding the scope of the invention. Accordingly, restrictive interpretation should not be made to the invention based on the examples described below.

Info nation regarding the main materials used for preparing a thermal dissipating structure in Example 1, Comparative Example 1 and Comparative Example 2 is described below.

Raw material of graphite: Artificial graphite (Model No. CPC-B) manufactured by CPC Corporation, Taiwan.

Binder: PVDF manufactured by KUREHA CO., LTD.

Substrate: Copper foil manufactured by Chang Chun Group.

Solvent A: Water.

Commercial graphene: Graphene nanosheets (GNs) manufactured by Xiamen Knano Graphene Technology Co., Ltd. (Agent: The-hydroxyl Applied Carbon Technology, Inc.)

### Example 1

The raw material of graphite is dispersed in a solvent A. Next, the homogeneous cavitation process is performed to the raw material of graphite dispersed in the solvent A to form the carbon material, wherein the homogeneous cavitation process is performed by applying 800 bar, 1300 bar and 1800 bar of pressure (from low pressure to high pressure). Meanwhile, the number of times of performing the homogeneous cavitation process is 3 times (the pressure applied in each time of the homogeneous cavitation process is increased from 800 bar to 1300 bar and further increased to 1800 bar). Thereafter, the binder is added and thoroughly stirred to be mixed to obtain a thermal dissipating slurry in Example 1.

### Comparative Example 1

The raw material of graphite is dispersed in the solvent A. Next, the binder is added and thoroughly stirred to be mixed to obtain a thermal dissipating slurry in Comparative Example 1.

### Comparative Example 2

The commercial graphene is dispersed in the solvent A. Next, the binder is added and thoroughly stirred to be mixed to obtain a thermal dissipating slurry in Comparative Example 2.

### Experiment 5

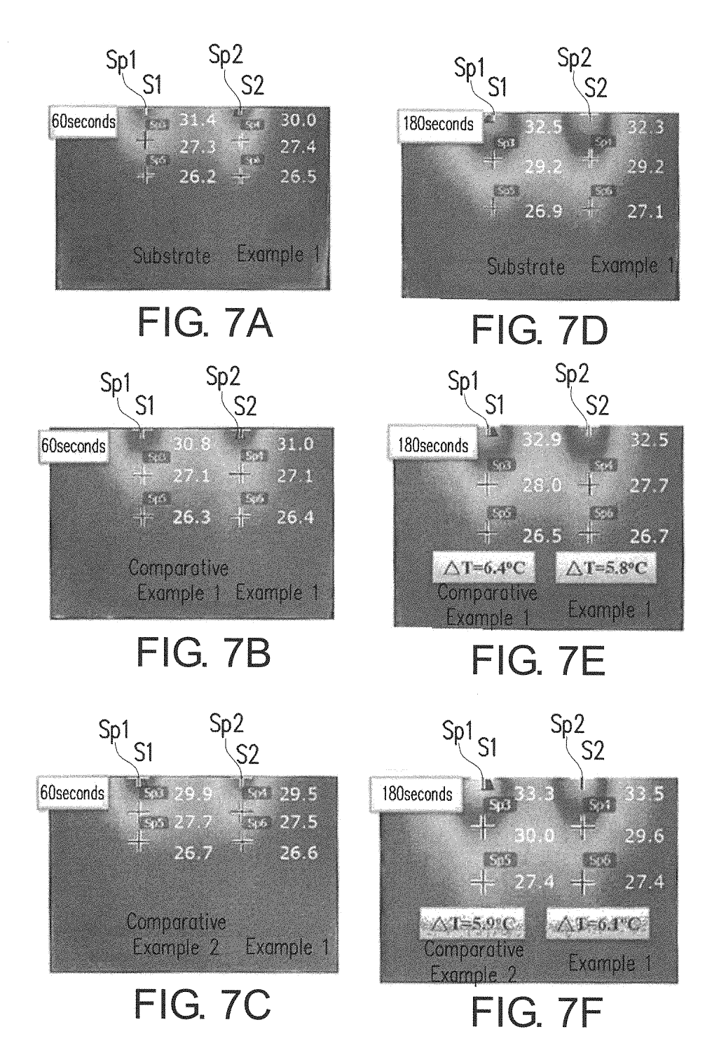

FIGS. 7A to 7F are comparative diagrams of thermal tests performed to a substrate, Example 1, Comparative Example 1 and Comparative Example 2 by using a thermography.

The thermal dissipating slurry in Example 1, Comparative Examples 1 and 2 are used to conduct a thermal test. The descriptions regarding the thermal test are provided below. Meanwhile, the test results are shown in FIGS. 7A to 7F.

Thermal Conduction Test

Referring to FIGS. 7A to 7F, the thermal dissipating slurry in Example 1, Comparative Example 1 and Comparative Example 2 respectively is coated on the substrate. Thereafter, the thermography is used for conducting the thermal conduction test. In a direction that is away from heat source (S1, S2), the temperature data at each measurement position (positions Sp1˜Sp6) on the substrate is measured; the temperature difference (ΔT) between the position that is the farthest from the heat source and the position that is the closest to the heat source is calculated to analyze the heat transfer efficiency. FIGS. 7A to 7C are thermal images after the heat source is provided for 60 seconds; FIGS. 7D to 7F are thermal images after the heat source is provided for 180 seconds. The positions Sp1˜Sp6 marked in the above-mentioned drawings represent the positions on the substrate where the temperature data is measured. Positions Sp1, Sp3 and Sp5 represent the temperature measuring positions on the substrate (see FIGS. 7A and 7D), in the Comparative Example 1 (see FIGS. 7B and 7E) and Comparative Example 2 (see FIGS. 7C and 7F). Positions Sp2, Sp4 and Sp6 represent the temperature measuring positions in Example 1 (see FIGS. 7A to 7F). The distance between the position Sp1 and heat source S1 is identical to the distance between the position Sp2 and heat source S2. The distance between the position Sp3 and heat source S1 is identical to the distance between the position Sp4 and heat source S2. The distance between the position Sp5 and heat source S1 is identical to the distance between the position Sp6 and heat source S2.

Referring to FIG. 7A, after providing the heat source for 60 seconds, the temperature difference between the position Sp5 and the position Sp1 on the substrate is 5.2° C. (the thermal dissipating slurry has not be coated yet). In Example 1, the temperature difference between the position Sp6 and the position Sp2 is 3.5° C. Referring to FIG. 7B, the temperature difference between the position Sp5 and the position Sp1 in Comparative Example 1 is 4.5° C. In Example 1, the temperature difference between the position Sp6 and the position Sp2 is 4.6° C. Referring to FIG. 7C, in Comparative Example 2, the temperature difference between the position Sp5 and the position Sp1 is 3.2° C. In Example 1, the temperature difference between the position Sp6 and the position Sp2 is 2.9° C.

Referring to FIG. 7D, after the heat source is provided for 180 seconds, the temperature difference between the position Sp5 and the position Sp1 on the substrate is 5.6° C. (the thermal dissipating slurry has not be coated yet). In Example 1, the temperature difference between the position Sp6 and the position Sp2 is 5.2° C. Referring to FIG. 7E, in Comparative Example 1, the temperature difference between the position Sp5 and the position Sp1 is 6.4° C. In Example 1, the temperature difference between the position Sp6 and the position Sp2 is 5.8° C. Referring to FIG. 7F, in Comparative Example 2, the temperature difference between the position Sp5 and the position Sp1 is 5.9° C. In Example 1, the temperature difference between the position Sp6 and the position Sp2 is 6.1° C.

All the experiment results show that, after the heat source is provided for 60 seconds or 180 seconds, the temperature difference between the position Sp6 and the position Sp2 in Example 1 (including the carbon material obtained via the homogeneous cavitation process) is smaller than the temperature difference between the position Sp5 and the position Sp1 on the substrate and in Comparative Example 1 (including the carbon material obtained without performing the homogeneous cavitation process). In view of the above, in Example 1, the thermal dissipating slurry prepared via the homogenous cavitation process has better heat transfer efficiency so that the heat generated from the heat source can be quickly transferred to the position on the substrate that is farther away from the heat source. As a result, there is smaller temperature difference between the position on the substrate that is farther away from the heat source and the position that is closer to the heat source.

Additionally, after the heat source has been provided for 60 seconds or 180 seconds, the temperature difference between the position Sp6 and the position Sp2 in Example 1 (including the carbon material obtained via the homogeneous cavitation process) is equivalent to the temperature difference between the position Sp5 and the position Sp1 in Comparative Example 2 (which uses commercial graphene). In view of the above, the heat transfer efficiency of the thermal dissipating slurry in Comparative Example 2 is equivalent to the thermal dissipating slurry in Example 1. Therefore, the process of preparing thermal dissipating slurry via homogeneous cavitation has the characteristics of being eco-friendly and can easily achieve mass production, and the thermal dissipating effect is also equivalent to the thermal dissipating slurry prepared by using commercial graphene.

In summary of the above, in the manufacturing method of thermal dissipating slurry and thermal dissipating structure provided by the invention, the homogeneous cavitation process is performed to the raw material of graphite to form the carbon material with high quality and few defects so that the obtained carbon material has good thermal conductivity and excellent mechanical property. In addition, the homogeneous cavitation process has the characteristics of being easy to perform, capable of continuous production and eco-friendly. Accordingly, the manufacturing method of thermal dissipating slurry and thermal dissipating structure provided by the above embodiments can manufacture the thermal dissipating slurry and thermal dissipating structure having good thermal conductivity via an eco-friendly method and can easily achieve mass production.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. A manufacturing method of a thermal dissipating slurry, comprising:
performing a homogeneous cavitation process to a raw material of graphite to form a carbon material; and
mixing the carbon material and a binder.

2. The manufacturing method of the thermal dissipating slurry according to claim 1, wherein the raw material of graphite comprises natural graphite, artificial graphite, pitch, activated carbon, single-wall carbon nanotubes, multi-wall carbon nanotubes or a combination thereof.

3. The manufacturing method of the thermal dissipating slurry according to claim 1, further comprising mixing the raw material of graphite in a solvent before performing the homogeneous cavitation process to the raw material of graphite.

4. The manufacturing method of the thermal dissipating slurry according to claim 3, wherein the solvent comprises water, ethanol, N-methyl-2-pyrrolidone (NMP), isopropanol or a combination thereof.

5. The manufacturing method of the thermal dissipating slurry according to claim 1, wherein a pressure of the homogeneous cavitation process is greater than 0 bar and less than 3000 bar.

6. The manufacturing method of the thermal dissipating slurry according to claim 1, wherein a temperature of the homogeneous cavitation process is higher than 4° C. and lower than 50° C.

7. The manufacturing method of the thermal dissipating slurry according to claim 1, wherein a number of times of performing the homogeneous cavitation process is more than 1 time and less than 100 times.

8. The manufacturing method of the thermal dissipating slurry according to claim 1, wherein the carbon material comprises a graphene, a few-layer graphene, a multi-layer graphene or a combination thereof.

9. A manufacturing method of a thermal dissipating structure, comprising:
performing a homogeneous cavitation process to a raw material of graphite to form a carbon material;
mixing the carbon material and a binder to form a thermal dissipating slurry; and
coating the thermal dissipating slurry on a substrate so as to form a thermal dissipating film on the substrate.

10. The manufacturing method of the thermal dissipating structure according to claim 9, wherein a pressure of the homogeneous cavitation process is greater than 0 bar and less than 3000 bar.

11. The manufacturing method of the thermal dissipating structure according to claim 9, wherein a temperature of the homogeneous cavitation process is higher than 4° C. and lower than 50° C.

12. The manufacturing method of the thermal dissipating structure according to claim 9, wherein a number of times of performing the homogeneous cavitation process is more than 1 time and less than 100 times.

13. The manufacturing method of the thermal dissipating structure according to claim 9, wherein the carbon material comprises a graphene, a few-layer graphene, a multi-layer graphene or a combination thereof.

14. The manufacturing method of the thermal dissipating structure according to claim 9, wherein the step of mixing the carbon material and the binder to form the thermal dissipating slurry further comprises mixing graphite or conductive carbon black in the thermal dissipating slurry.

15. The manufacturing method of the thermal dissipating structure according to claim 9, wherein a material of the substrate comprises a metallic material, a polymer material or a combination thereof, and the metallic material comprises copper, aluminum or a combination thereof, the polymer material comprises polyethylene terephthalate.

16. The manufacturing method of the thermal dissipating structure according to claim 9, wherein the thermal dissipating film is formed on a first surface of the substrate and a second surface opposite to the first surface.

17. The manufacturing method of the thermal dissipating structure according to claim 9, wherein a thickness of the thermal dissipating film is from 10 μm to 100 μm.

18. The manufacturing method of the thermal dissipating structure according to claim 9, wherein a thickness of the substrate is from 10 μm to 50 μm.

19. The manufacturing method of the thermal dissipating structure according to claim 9, further comprising performing a rolling process to the thermal dissipating film after forming the thermal dissipating film on the substrate.

20. The manufacturing method of the thermal dissipating structure according to claim 19, further comprising performing a drying process to the thermal dissipating film before performing the rolling process to the thermal dissipating film.
